(19) United States
(12) Patent Application Publication
(10) Pub. No.: US 2018/0089999 A1
(43) Pub. Date: Mar. 29, 2018

(54) Highway Traffic Control Device

(71) Applicant: Peter Zal, Corona, CA (US)

(72) Inventor: Peter Zal, Corona, CA (US)

(21) Appl. No.: 15/720,394

(22) Filed: Sep. 29, 2017

Related U.S. Application Data
(60) Provisional application No. 62/401,726, filed on Sep. 29, 2016.

(51) Int. Cl. G08G 1/095; G08G 1/048; G08G 1/052

(52) U.S. Cl. CPC G08G 1/095; G08G 1/052; G08G 1/048

(57) ABSTRACT

A highway traffic control device comprising: a plurality of sensors; receiver member; a computer member; a warning projector; and a transceiver member. The plurality of sensors includes a rain sensor; a fog sensor, and a velocity sensor. The transceiver member is adapted to communicate electronically with other highway traffic control devices in order to share the information from the plurality of sensors and the computer member, and adapted to receive information from the other highway traffic control devices in order to increase the efficiency and safety of vehicles traveling on the roadway. A highway traffic control system is also disclosed herein including a highway traffic sign and highway traffic control device.

### CROSS-REFERENCE TO RELATED APPLICATION

The present application is related to and claims priority from prior provisional application Ser. No. 62/401,726, filed Sep. 29, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of traffic control devices and more specifically relates to a highway traffic control device, a set of sensors on the Freeway and highway structured and arranged to warn a driver of current road conditions or an event to promote driver safety.

### 2. Description of the Related Art

Traffic signs or road signs are signs erected at the side of or above roads to give instructions or provide information to road users. The earliest signs were simple wooden or stone milestones. With traffic volumes increasing since the 1930s, many countries have adopted pictorial signs or otherwise simplified and standardized their signs to overcome language barriers, and enhance traffic safety. A warning sign is a type of traffic sign that indicates a hazard ahead on the road that may not be readily apparent to a driver. While designs vary, they usually take the shape of an equilateral triangle with a white background and thick red border.

Regulating and controlling highway traffic is very important for safety of the general public, especially where the speed limit is very high and traffic is approaching a road obstruction such as an accident ahead or a construction zone where workers are in close proximity to the traffic. Usually by the time a driver sees a highway barrier for detours or when approaching emergency closures it is too late for taking a different route. It may be miles of backtracking to go back to a turnoff that leads to a different route around the obstruction. Therefore, a need exists for a device which is more visible from a longer distance to warn drivers sooner of dangers and road closures ahead in real time.

Various attempts have been made to solve problems found in warning device art. Among these are found in: U.S. Pub. No. 6633238 to Lemelson et al.; U.S. Pat. No. 7,573,401 to Roger L. Wabeke; and U.S. Pub. No. 7148813 to Frederick T. Bauer. This prior art is representative of traffic warning device.

Ideally, a highway traffic control device should be user-friendly and safe in-use and, yet should operate reliably and be manufactured at a modest expense. Thus, a need exists for a highway traffic control device, a set of sensors on the Freeway and highway structured and arranged to warn a driver of current road conditions or an event to promote driver safety and to avoid the above-mentioned problems.

### BRIEF SUMMARY OF THE INVENTION

In view of the foregoing disadvantages inherent in the known traffic control devices art, the present invention provides a highway traffic control device. The general purpose of the present invention, which will be described subsequently in greater detail is to provide a highway traffic control device, a set of sensors on the Freeway and highway structured and arranged to warn a driver of current road conditions or an event to promote driver safety.

A highway traffic control device comprising: a plurality of sensors; receiver member; a computer member; a warning projector; and a transceiver member. The plurality of sensors includes a rain sensor; a fog sensor, and a velocity sensor. The rain sensor is adapted to detect rain falling on a roadway and send an electronic signal to a receiver to supply information pertaining to the amount and intensity of the rain falling on said roadway. The fog sensor is adapted to detect fog in an area surrounding said roadway and send an electronic signal to the receiver to supply information pertaining to the density of the fog in the area of the roadway. The velocity sensor is adapted to detect and determine the velocity of a vehicle traveling on the roadway and send an electronic signal to said receiver to supply information pertaining to the velocity of said traveling on said roadway. The receiver member is adapted to receive the electronic signals from said plurality of sensors and send said information thereof to a computer member.

The computer member is adapted to receive the information from the receiver member and calculate appropriate speeds for vehicles to be traveling on the roadway based on the information; and wherein the computer member is adapted to send the information to a warning projector. The warning projector is electrically connected to the computer member and adapted to project informational verbiage and at least one warning light signal to be viewed by the drivers of the vehicles traveling on the roadway to thereby increase the efficiency and safety of vehicles traveling on the roadway. The transceiver member is electrically connected with the computer member. The transceiver member is adapted to communicate electronically with other highway traffic control devices in order to share the information from said plurality of sensors and the computer member, and adapted to receive information from the other highway traffic control devices in order to increase the efficiency and safety of vehicles traveling on the roadway.

A highway traffic control system is also disclosed herein including a highway traffic sign and highway traffic control device. The highway traffic sign includes a placard member and a support member. The placard member is adapted to have symbols or indicia printed thereon. The support member is connected to the placard member and adapted to support the placard member above a roadway for drivers to view while driving.

The present invention holds significant improvements and serves as a highway traffic control device. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Highway Traffic Control Device, constructed and operative according to the teachings of the present invention.

FIG. 1 shows a perspective view illustrating Highway Traffic Control Device according to an embodiment of the present invention.

FIG. 2 is a perspective view illustrating a Highway Traffic Control Device according to an embodiment of the present invention.

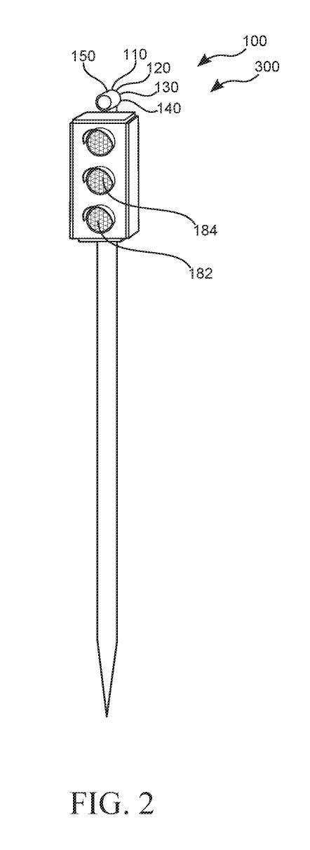

FIG. 3 is a perspective view illustrating a highway traffic control having a highway traffic sign and the highway traffic control device according to an embodiment of the present invention of FIG. 1.

FIG. 4 is a perspective view illustrating a highway traffic control having a highway traffic sign and the highway traffic control device in an in-use condition according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a traffic warning device and more specifically relates to a highway traffic control device, a set of sensors on the Freeway and highway structured and arranged to warn a driver of current road conditions or an event to promote driver safety.

Generally speaking, the highway traffic control device is a sensor light mounted on top of traffic lights or roadway signs which can be used to activate lights or messages to warn traffic of danger or road closures ahead. Advanced warning may be able to save drivers miles of backtracking to find alternate routes or provide early warning of an accident or obstruction in the road ahead. One advantage is that it may be able to prevent miles of backed up or gridlocked traffic.

The device is a sensor that receives a radio signal and actuates either a portable or a non portable sign such as a traffic light or a road warning sign. The road warning sign may have a message and a light that is illuminated or the sign may be an LCD screen that is able to display any verbiage required for a given situation from a remote location such as police dispatch or from some other suitable source.

The Unit's circuit should include
Humidity=rain sensor—to prevent sudden loss of control
Visibility=fog sensor—to prepare the driver for low visibility
Inferred beam for moving cars detection to calibrate and set the appropriate light based on the speed.
RFcommunication: Transceiver to communicate with other units to prepare coming traffic of an event.
Selectively States like California can use vibration sensors to sense earth quake to warn and prevent cars from driving on bridges.

Lights: green, orange, Red and flashing whenever applies.
Unit must be able to signal to the previous one to activate it to alert the traffic in case of any detection.

The distance of every sensor is based on every states needs and requirement. A separate receiver module can be installed on vehicles to receive the warning signal from the sensors on the highway without actually watching the signal signs. This system can prevent freeway pile-up on rainy and snowy or night as well as sudden loss of visibility from fog.

The present invention can control and regulate traffic movement and prepare drivers of upcoming event Seeing a red light from far away will give the driver a chance to get off the freeway. Example [If the sensor's light turns red due to a major accident that will bring the traffic to stop the Transceiver will signal number two to activate and turn the signal to flashing red so upcoming vehicles Slow down or prepare for other options, a foggy HWY or bad visibility will also trigger the previous sensor To activate and warn drivers. Today's average speed on freeways is about 80 mph, in the event of rain Particularly in areas like east coast where is sunny and suddenly a big cloud and thunder storm the rain Sensor will warn speeding car to slowdown

The Green light from far can put your driving at ease and orange light keeps the drivers alert. The Unit can use solar cells and all electronic parts are in use in different technologies. The circuit must be designed in a way so it can be upgraded with add on circuit modules such as GPS Communications sending data of an event to GPS satellite so it can be seen on every GPS receiver. GPS transmitter does not need to be installed on every sensor on the highway, only the second sensor after it was triggered by the previous sensor . . . . It can save life over and over

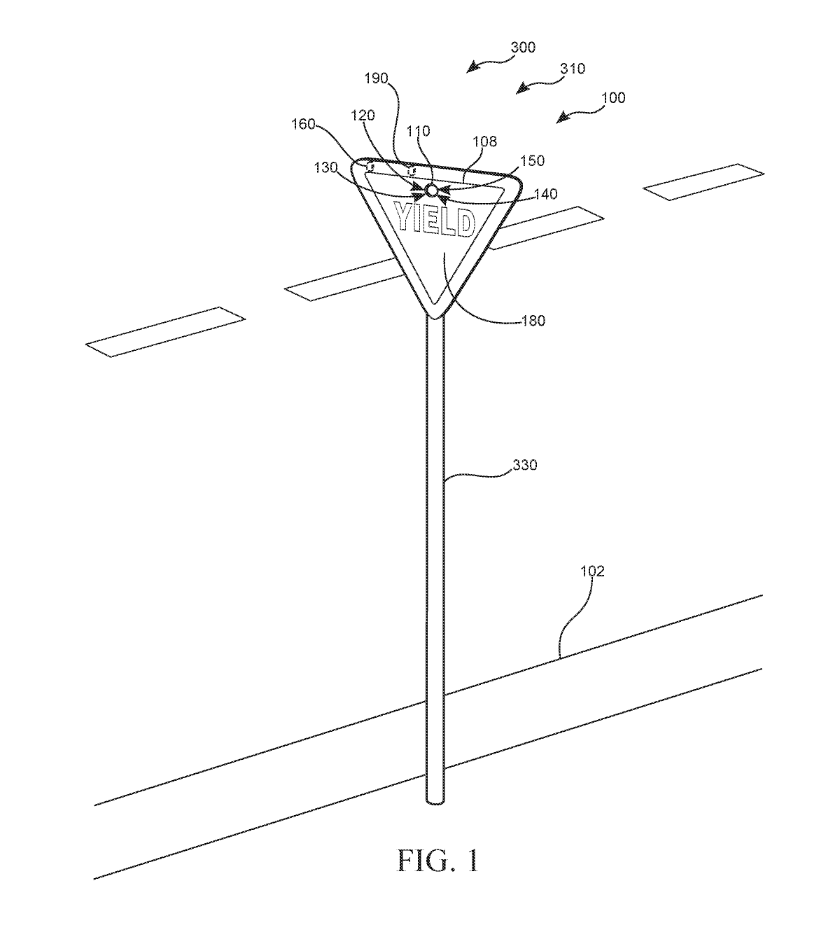

Referring now to FIGS. 1 & 2, showing perspective views illustrating highway traffic control device 100 according to an embodiment of the present invention of FIG. 1.

Highway traffic control device 100 is disclosed herein in a preferred embodiment comprises: plurality of sensors 110; receiver member 160; computer member 170; warning projector 180; and transceiver member 190. Plurality of sensors 110 includes rain sensor 120; fog sensor 130, and velocity sensor 140. Rain sensor 120 is adapted to detect rain falling on roadway 102 and send an electronic signal to receiver 160 to supply information pertaining to the amount and intensity of the rain falling on roadway 102. Fog sensor 130 is adapted to detect fog in an area surrounding roadway 102 and send an electronic signal to receiver 160 to supply information pertaining to the density of the fog in the area of roadway 102. Velocity sensor 140 is adapted to detect and determine the velocity of vehicle 410 traveling on roadway 102 and send an electronic signal to receiver 160 to supply information pertaining to the velocity of the traveling on roadway 102. Plurality of sensors 110 further includes vibration sensor 150. Vibration sensor 150 is adapted to detect vibrations within roadway 102 and send an electronic signal to receiver 160 to supply information pertaining to the amplitude, intensity, duration, and frequencies of the vibrations within roadway 102.

Receiver member 160 is adapted to receive the electronic signals from plurality of sensors 120 and send the information thereof to computer member 170. Receiver member 170 is adapted to send information directly to liquid crystal display screen 108, such that emergency personnel can send the highway traffic control device 100 important information to be displayed on liquid crystal display screen 108.

Computer member 170 is adapted to receive the information from receiver member 160 and calculate appropriate speeds for vehicles 410 to be traveling on roadway 102 based on the information; and wherein computer member 170 is adapted to send information to warning projector 180.

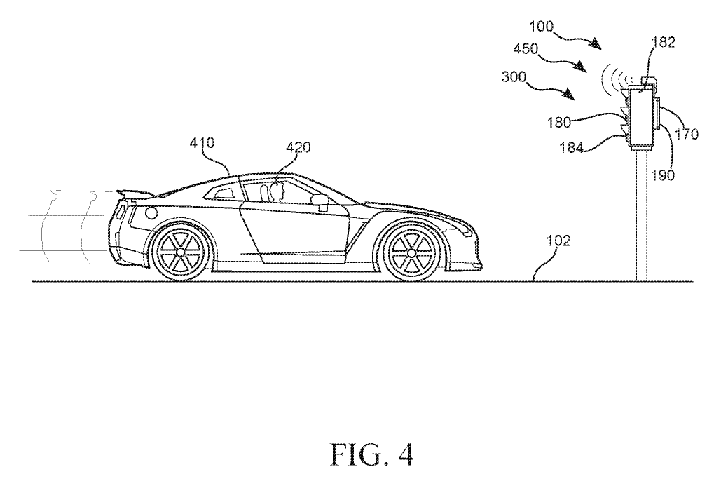

Warning projector 180 is electrically connected to computer member 170 and adapted to project informational verbiage and at least one warning light signal 182 to be viewed by drivers 420 of vehicles 410 traveling on roadway 102 to thereby increase the efficiency and safety of vehicles 410 traveling on roadway 102. Warning projector 180 is formed as light emitting bulb member 184 as shown in in-use condition 450 of FIG. 4. The warning projector is formed from at least one light emitting diode member.

Transceiver member 190 is electrically connected with computer member 170. Transceiver member 190 is adapted to communicate electronically with other highway traffic control devices 100 in order to share said information from plurality of sensors 110 and computer member 170, and adapted to receive information from other highway traffic control devices 100 in order to increase the efficiency and safety of vehicles 410 traveling on roadway 102. Transceiver 190 is adapted to communicate using radio frequencies between 3 kHz to 300 GHz. Transceiver 190 is adapted to communicate using radio frequencies between 3 kHz to 300 GHz.

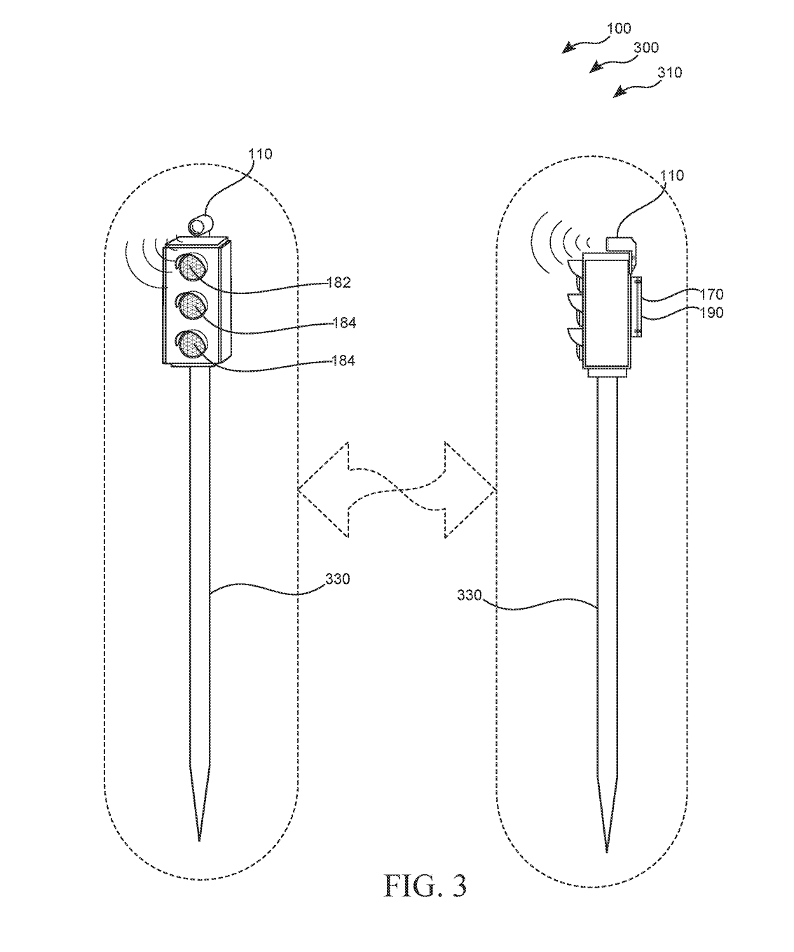

Referring now to FIG. 3 is a perspective view illustrating highway traffic control 300 having highway traffic sign 310 and the highway traffic control device 100 according to an embodiment of the present invention of FIG. 1.

Highway traffic control system 300 is also disclosed herein including highway traffic sign 310 and highway traffic control device 100. Highway traffic sign 310 includes a placard member 320 and support member 330. Placard member 320 is adapted to have symbols or indicia printed thereon. Support member 330 is connected to placard member 320 and adapted to support placard member 320 above roadway 102 for drivers 420 to view while driving.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A highway traffic control device comprising:
a plurality of sensors including:
a rain sensor;
wherein said rain sensor is adapted to detect rain falling on a roadway and send an electronic signal to a receiver to
supply information pertaining to the amount and intensity of said rain falling on said roadway;
a fog sensor;
wherein said fog sensor is adapted to detect fog in an area surrounding said roadway and send an electronic signal to said
receiver to supply information pertaining to the density of said fog in said area of said roadway; and
a velocity sensor;
wherein said velocity sensor is adapted to detect and determine the velocity of a vehicle traveling on said roadway and send an electronic signal to said receiver to supply information pertaining to the velocity of said traveling on said roadway;
a receiver member;
wherein said receiver member is adapted to receive said electronic signals from said plurality of sensors and send said information thereof to a computer member;
a computer member;
wherein said computer member is adapted to receive said information from said receiver member and calculate appropriate speeds for vehicles to be traveling on said roadway based on said information;
and wherein said computer member is adapted to send said information to a warning projector;
a warning projector;
wherein said warning projector is electrically connected to said computer member and adapted to project informational verbiage and at least one warning light signal to be viewed by said drivers of said vehicles traveling on said roadway to thereby increase the efficiency and safety of vehicles traveling on said roadway; and
a transceiver member;
wherein said transceiver member is electrically connected with said computer member; and
wherein said transceiver member is adapted to communicate electronically with other said highway traffic control devices in order to share said information from said plurality of sensors and said computer member, and adapted to receive information from said other highway traffic control devices in order to increase the efficiency and safety of vehicles traveling on said roadway.

2. The highway traffic control device of claim 1, wherein said plurality of sensors further includes a vibration sensor; wherein said vibration sensor is adapted to detect vibrations within said roadway and send an electronic signal to said receiver to supply information pertaining to the amplitude, intensity, duration, and frequencies of said vibrations within said roadway.

3. The highway traffic control device of claim 1, wherein said transceiver is adapted to communicate using radio frequencies between 3 kHz to 300 GHz.

4. The highway traffic control device of claim 1, wherein said warning projector is formed as a light emitting bulb member.

5. The highway traffic control device of claim 1, wherein said warning projector is formed from at least one light emitting diode member.

6. The highway traffic control device of claim 1, wherein said warning projector is formed from a plurality of light emitting diode members; and wherein each of said plurality of light emitting diode members emit a colored light chosen from a list of emit a colored light consisting of green, orange, and red.

7. The highway traffic control device of claim 1, wherein said warning projector is formed as a liquid crystal display screen.

8. The highway traffic control device of claim 7, wherein said liquid crystal display screen is adapted to project verbiage thereon.

9. The highway traffic control device of claim 7, wherein said receiver member is adapted to send information directly to said liquid crystal display screen, such that emergency personnel can send said highway traffic control device important information to be displayed on said liquid crystal display screen.

10. A highway traffic control system comprising:
a highway traffic sign including:
a placard member;
wherein said placard member is adapted to have symbols or indicia printed thereon; and
a support member;
wherein said support member is connected to said placard member and adapted to support said placard member above a roadway for drivers to view while driving; and
a highway traffic control device comprising:
a plurality of sensors including:
a rain sensor;
wherein said rain sensor is adapted to detect rain falling on a roadway and send an electronic signal to a receiver to supply information pertaining to the amount and intensity of said rain falling on said roadway;
a fog sensor;
wherein said fog sensor is adapted to detect fog in an area surrounding said roadway and send an electronic signal to said receiver to supply information pertaining to the density of said fog in said area of said roadway; and
a velocity sensor;
wherein said velocity sensor is adapted to detect and determine the velocity of a vehicle traveling on said roadway and send an electronic signal to said receiver to supply information pertaining to the velocity of said traveling on said roadway;
a receiver member;
wherein said receiver member is adapted to receive said electronic signals from said plurality of sensors and send said information thereof to a computer member;
a computer member;
wherein said computer member is adapted to receive said information from said receiver member and calculate appropriate speeds for vehicles to be traveling on said roadway based on said information; and wherein said computer member is adapted to send said information to a warning projector;
a warning projector;
wherein said warning projector is electrically connected to said computer member and adapted to project informational verbiage and at least one warning light signal to be viewed by said drivers of said vehicles traveling on said roadway to thereby increase the efficiency and safety of vehicles traveling on said roadway; and
a transceiver member;
wherein said transceiver member is electrically connected with said computer member; and
wherein said transceiver member is adapted to communicate electronically with other said highway traffic control devices in order to share said information from said plurality of sensors and said computer member, and adapted to receive information from said other highway traffic control devices in order to increase the efficiency and safety of vehicles traveling on said roadway;
wherein said highway traffic control device is adapted to be removably attached to an upper portion of said placard member of said highway traffic sign for drivers to view while driving.

11. The highway traffic control system of claim 10, wherein said plurality of sensors further includes a vibration sensor; wherein said vibration sensor is adapted to detect vibrations within said roadway and send an electronic signal to said receiver to supply information pertaining to the amplitude, intensity, duration, and frequencies of said vibrations within said roadway.

12. The highway traffic control system of claim 10, wherein said transceiver is adapted to communicate using radio frequencies between 3 kHz to 300 GHz.

13. The highway traffic control system of claim 10, wherein said warning projector is formed as a light emitting bulb member.

14. The highway traffic control system of claim 10, wherein said warning projector is formed from at least one light emitting diode member.

15. The highway traffic control system of claim 10, wherein said warning projector is formed from a plurality of light emitting diode members; and wherein each of said plurality of light emitting diode members emit a colored light chosen from a list of emit a colored light consisting of green, orange, and red.

16. The highway traffic control system of claim 10, wherein said warning projector is formed as a liquid crystal display screen.

17. The highway traffic control system of claim 16, wherein said liquid crystal display screen is adapted to project verbiage thereon.

18. The highway traffic control system of claim 16, wherein said receiver member is adapted to send information directly to said liquid crystal display screen, such that emergency personnel can send said highway traffic control device important information to be displayed on said liquid crystal display screen.
